(19) United States
(12) Patent Application Publication
(10) Pub. No.: US 2009/0147676 A1
(43) Pub. Date: Jun. 11, 2009

(54) Communication system, communication terminal, relay node, communication method used therein, and program thereof

(76) Inventor: Hideyuki Shimonishi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/990,990

(22) PCT Filed: Aug. 21, 2006
(86) PCT No.: PCT/JP2006/316303

§ 371 Date: Feb. 26, 2008

(30) Foreign Application Priority Data
Aug. 31, 2005 (JP) 2005 250428

(51) Int. Cl. H04L 12/56

(52) U.S. Cl. 370/230

(57) ABSTRACT

In a terminal (1), when a connection is established, a packet generated by a data generating part (11) is outputted from a packet transmitting part (13). In the terminal (1), an ACK receiving part (14) receives an ACK packet transmitted as a receipt acknowledgement response to the foregoing transmitted packet. In the terminal (1), when the ACK packet is received, a cumulative band difference calculating part (18) calculates an accumulation or history of differences each between a target band and an actual output band. A target congestion window calculating part (20) defines, based on the cumulative band difference, a target congestion window. A congestion window limited-value calculating part (19) defines the upper limit of the congestion window. In the terminal (1), when the discarding of a packet is detected, it is not that the congestion window is reduced by one-half but that a smaller one of the target congestion window and the congestion window limited-value is used as a new congestion window.

### TECHNICAL FIELD

The present invention relates to communication system, communication terminal, relay node, and communication method used therein and program thereof, and particularly to a communication system with a congestion control mechanism and a throughput control mechanism in a session layer.

### BACKGROUND ART

Currently, a variety of kinds of applications are employed in a network, and they require different levels of quality of the network. For example, an application for which immediacy is demanded requires a shorter transfer time, a higher band, or a lower packet discard probability than those in other applications. On the other hand, an application for which no immediacy is demanded tolerates a longer transfer time, a lower band, or higher discard than those in applications for which immediacy is demanded.

A first technique for implementing application-based band control in a network is a band allocation scheme by a network node. The band allocation scheme proposed includes “Integrated Services” (see Non-patent Document 1, for example), in which an optimal band is allocated to each session at a router.

A second technique for implementing application-based band control in a network is a band differentiation scheme by transport layer control at a terminal. In TCP (transmission control protocol), which is a representative transport protocol, a parameter called window size (the amount of data that can be consecutively transmitted/received without a delivery acknowledgement) is regulated to control a transmission band. The window size is ordinarily controlled depending upon the degree of congestion of a network.

Specifically, in TCP-Reno (see Non-patent Document 2, for example), which is currently the most widespread version, a congestion window is incremented at a certain rate while no congestion is detected, and the congestion window is decremented by half upon detection of congestion, so that the congestion window is controlled to achieve a high throughput to the extent that congestion is prevented in a network.

On the other hand, there has been proposed another scheme in which the congestion window is decremented once for a plurality of number of times of congestion detection for a high-priority session, rather than decrementing the congestion window each time congestion is detected (see Patent Document 1, for example). Moreover, still another congestion control scheme has been proposed, in which control is made such that one TCP session is given a band equivalent to that for a plurality of TCP sessions (see Non-patent Document 3, for example). By using any of these schemes, it is possible to obtain different bands for different TCP sessions.

A third technique for implementing application-based band control in a network is a band control scheme by transport layer control at a terminal. For example, the band control scheme proposed involves determining a target value of a congestion window based on an estimated line band, and based thereon, controlling increment/decrement of the congestion window in a TCP session (see Patent Document 2 and Non-patent Document 4, for example). By specifying beforehand a fixed band instead of the estimated band, it is believed that band control in conformance with a target band is achieved.

In TCP, the parameter called window size is regulated to control a transmission band. The window size is ordinarily controlled depending upon the degree of congestion of a network. Specifically, in TCP-Reno, which is currently the most widespread version, the congestion window is incremented at a certain rate while no congestion is detected, and the congestion window is decremented by half upon detection of congestion, so that the congestion window is controlled to achieve a high throughput to the extent that congestion is prevented in a network (see Non-patent Document 2, for example).

An advantage of the aforementioned second and third techniques is that, whereas the first technique requires all nodes in a network to accommodate band control, the second technique merely requires a transmitting terminal to accommodate band control.

Patent Document 1: Japanese Patent Application Laid Open No. H09-307871

Patent Document 2: Japanese Patent Application Laid Open No. 2005-365193

Non-patent Document 1: R. Braden, D. Clark, and S. Shenker, “Integrated Services in the Internet Architecture: an Overview” (IETF RFC1633, 1994)

Non-patent Document 2: W. Stevens, “TCP Slow Start, Congestion Avoidance, Fast Retransmit, and Fast Recovery Algorithms” (RFC2001, January 1997)

Non-patent Document 3: J. Crowroft and P. Oechcslin, “Differentiated end-to-end Internet services using a weighted proportional fair sharing TCP” (ACM Comput. Commun. Rev., Vol. 28, No. 3, pp. 53-69, July 1998)

Non-patent Document 4: C. Casetti, M. Gerla, S. Mascolo, M. Y. Sanadidi, and R. Wang, “TCP Westwood: Bandwidth Estimation for Enhanced Transport over Wireless Links” (In proc. of Mobicom, 2001)

### DISCLOSURE OF THE INVENTION

### Problems to be Solved by the Invention

The first prior art for implementing band control has a problem of higher installation cost. Since the first technique requires a preferential control scheme to be implemented in nodes in a network, nodes already installed in the network must be replaced with those accommodating the band control scheme. Moreover, in addition to defining a session-based parameter such as a target band in a transmitting terminal, the parameter must be defined in all nodes; therefore, cost of a node, and hence, cost of operational management, becomes high.

The second prior art for implementing band differentiation is capable of differentiating bands; however, it has a problem that when absolute target quality is defined, the technique cannot ensure quality following the target.

The third prior art for implementing band control has a problem that since a target value for the congestion window size is determined irrespective of the congestive condition of a network, serious congestion is sometimes brought out to significantly degrade the throughput. In the third art, when an attempt to improve the throughput is made for a target band greater than an available band of a network by increasing the window size, packets beyond the available band are discarded in the network. In such a case, and when the target band is significantly different from the available band, a large number of packets should be discarded, and retransmission timeout in TCP takes place to cause a communication downtime of the order of seconds, thus resulting in a significantly degraded throughput.

On the other hand, in traditional TCP in such a case, the window size is reduced depending upon the degree of congestion of a network, and therefore, not so many packets are discarded as to give rise to retransmission timeout. Therefore, in such a case, the second art induces an adverse effect to lower the throughput as compared with a case in which traditional TCP is employed.

It is therefore an object of the present invention to solve the aforementioned problems and provide communication system, communication terminal, relay node, and communication method used therein and program thereof capable of controlling the throughput of a TCP session according to a target band without putting a network into a serious congestive state.

### Means for Solving the Problems

The 1st invention for solving the aforementioned problems is characterized that a communication system for conducting data transmission/reception among a plurality of communication terminals via a network, and including a relay node for relaying communication between said communication terminals, characterized in that either said communication terminal or said relay node comprises holding means for holding an accumulation of a difference between a preset target band and an actually output band or history of said difference, and means for changing a congestion control parameter representing an increment and a decrement of a congestion window based on a value held in said holding means.

The 2nd invention for solving the above-mentioned problem, in the above-mentioned 1st invention, is characterized in that either said communication terminal or said relay node sets a smaller decrement of a congestion window in a congestive state as a value held in said holding means becomes larger.

The 3rd invention for solving the above-mentioned problem, in the above-mentioned 1st invention, is characterized in that either said communication terminal or said relay node includes means for modifying said target band based on a value held in said holding means.

The 4th invention for solving the above-mentioned problem, in the above-mentioned 1st invention, is characterized in that either said communication terminal or said relay node comprises means for deriving a value of a target congestion window based on either a preset target band or a modified target band, and means for setting a decrement of a congestion window in a congestive state based on a value of said target congestion window.

The 5th invention for solving the above-mentioned problem, in the above-mentioned 1st invention, is characterized in that a communication terminal on a transmitting side includes a first counter for incrementing a count value according to an amount of generated transmitted data and decrementing the count value according to said target band, and a second counter for incrementing a count value along with the count value decremented at said first counter and decrementing the count value according to an amount of data actually output from the terminal itself, and the count value of said second counter is defined as a value held in said holding means.

The 6th invention for solving the above-mentioned problem, in one of the above-mentioned 1st to 4th inventions, is characterized in that said relay node includes a first counter for incrementing a count value according to an amount of received data and decrementing the count value according to said target band, and a second counter for incrementing a count value along with the count value decremented at said first counter and decrementing the count value according to an amount of data actually output from the node itself, and the count value of said second counter is defined as a value held in said holding means.

The 7th invention for solving the above-mentioned problem, in one of the above-mentioned 2nd to 6th inventions, is characterized in that, when the congestion window after decremented is equal to or smaller than a half of the congestion window before decremented, either said communication terminal or said relay node sets said congestion window after decremented to a half of said congestion window before decremented.

The 8th invention for solving the above-mentioned problem, in one of the above-mentioned 1st to 4th inventions, is characterized in that either said communication terminal or said relay node includes means for calculating an upper limit of the congestion window based on a degree of congestion of said network, and in decrementing the congestion window in a congestive state, at least decrements said congestion window equal to or smaller than said upper limit.

The 9th invention for solving the above-mentioned problem, in the above-mentioned 8th invention, is characterized in that either said communication terminal 5 or said relay node calculates the upper limit of said congestion window by performing subtraction of a certain value from, or multiplication of a certain value with, a value of the congestion window immediately before detection of packet discard.

The 10th invention for solving the above-mentioned problem, in the above-mentioned 8th invention, is characterized in that either said communication terminal or said relay node sets the upper limit of said congestion window to a smaller value in proportion to a frequency of retransmission timeout.

The 11th invention for solving the above-mentioned problem, in the above-mentioned 1st invention, is characterized in that characterized in that either said communication terminal or said relay node includes means for setting a larger increment of the congestion window in a non-congestive state as a value held in said holding means becomes larger.

The 12th invention for solving the above-mentioned problem, in the above-mentioned 1st invention, is characterized in that either said communication terminal or said relay node includes means for deriving a value of the target congestion window based on either a preset target band or a modified target band, and means for setting an increment of the congestion window in a non-congestive state based on a value of said target congestion window and a value of a current congestion window.

The 13th invention for solving the above-mentioned problem, in the above-mentioned 12th invention, is characterized in that either said communication terminal or said relay node includes means for changing an increment of said congestion window in a non-congestive state to a larger value when a value of the current congestion window is smaller than a value of said target congestion window, and means for changing said increment to a smaller value as a round trip transfer delay time becomes larger.

The 14th invention for solving the above-mentioned problem is a communication system for conducting data transmission/reception among a plurality of communication terminals via a network, and including a relay node for relaying communication between said communication terminals, characterized in that either a communication terminal on a receiving side or said relay node comprises holding means for holding an accumulation of a difference between an input band from a communication terminal on a transmitting side and a target band or history of said difference, and means for dividing delivery acknowledgement response packets to be sent back to said communication terminal on a transmitting side based on a value held in said holding means.

The 15th invention for solving the above-mentioned problem, in the above-mentioned 14th invention, is characterized in that either said communication terminal on a receiving side or said relay node includes means for dividing a plurality of delivery acknowledgement response packets having a gradually increasing sequence number for acknowledging reception of one data packet and sending the delivery acknowledgement response packets back to said communication terminal on a transmitting side, and sets the number of said divided delivery acknowledgement response packets to a larger value as a value held in said holding means becomes larger.

The 16th invention for solving the above-mentioned problem is a communication terminal for conducting data transmission/reception with other communication terminal via a network, characterized in comprising holding means for holding an accumulation of a difference between a preset target band and an actually output band or history of said difference, and means for changing a congestion control parameter representing an increment and a decrement of a congestion window based on a value held in said holding means.

The 17th invention for solving the above-mentioned problem, in the above-mentioned 16th invention, is characterized in setting a smaller decrement of the congestion window in a congestive state as a value held in said holding means becomes larger.

The 18th invention for solving the above-mentioned problem, in the above-mentioned 16th invention, is characterized in including means for modifying said target band based on a value held in said holding means.

The 19th invention for solving the above-mentioned problem, in the above-mentioned 18th invention, is characterized in including means for deriving a value of a target congestion window based on either the preset target band or the modified target band, and means for setting a decrement of said congestion window in a congestive state based on a value of said target congestion window.

The 20th invention for solving the above-mentioned problem, in one of the above-mentioned 16th to 19th inventions, is characterized in including a first counter for incrementing a count value according to an amount of generated transmitted data and decrementing the count value according to said target band, and a second counter for incrementing a count value along with the count value decremented at said first counter and decrementing the count value according to an amount of data actually output by the terminal itself, and that the count value of said second counter is defined as a value held in said holding means.

The 21st invention for solving the above-mentioned problem, in one of the above-mentioned 16th to 19th inventions, is characterized in that, when the congestion window after decremented is equal to or smaller than a half of the congestion window before decremented, said congestion window after decremented is set to a half of said congestion window before decremented.

The 22nd invention for solving the above-mentioned problem, in one of the above-mentioned 16th to 19th inventions, is characterized in including means for calculating an upper limit of the congestion window based on a degree of congestion of said network, and in decrementing the congestion window in a congestive state, at least decrementing said congestion window equal to or smaller than said upper limit.

The 23rd invention for solving the above-mentioned problem, in the above-mentioned 22nd invention, is characterized in calculating the upper limit of said congestion window by performing subtraction of a certain value from, or multiplication of a certain value with, a value of the congestion window immediately before detection of packet discard.

The 24th invention for solving the above-mentioned problem, in the above-mentioned 22nd invention, is characterized in setting the upper limit of said congestion window to a smaller value in proportion to a frequency of retransmission timeout.

The 25th invention for solving the above-mentioned problem, in the above-mentioned 16th invention, is characterized in including means for setting a larger increment of the congestion window in a non-congestive state as a value held in said holding means becomes larger.

The 26th invention for solving the above-mentioned problem, in the above-mentioned 16th invention, is characterized in including means for deriving a value of the target congestion window based on either a preset target band or a modified target band, and means for setting an increment of the congestion window in a non-congestive state based on a value of said target congestion window and a value of a current congestion window.

The 27th invention for solving the above-mentioned problem, in the above-mentioned 26th invention, is characterized in including means for changing an increment of said congestion window in a non-congestive state to a larger value when a value of the current congestion window is smaller than a value of said target congestion window, and means for changing said increment to a smaller value as a round trip transfer delay time becomes larger.

The 28th invention for solving the above-mentioned problem is a communication terminal for conducting data transmission/reception with other communication terminal via a network, characterized in comprising holding means for holding an accumulation of a difference between an input band from a communication terminal on a transmitting side and a target band or history of said difference, and means for dividing delivery acknowledgement response packets to be sent back to said communication terminal on a transmitting side based on a value held in said holding means.

The 29th invention for solving the above-mentioned problem, in the above-mentioned 28th invention, is characterized in including means for dividing a plurality of delivery acknowledgement response packets having a gradually increasing sequence number for acknowledging reception of one data packet and sending the delivery acknowledgement response packets back to said communication terminal on a transmitting side, and that the number of said divided delivery acknowledgement response packets is set to a larger value as a value held in said holding means becomes larger.

The 30th invention for solving the above-mentioned problem is a relay node in a communication system for conducting data transmission/reception among a plurality of communication terminals via a network, for relaying communication between said communication terminals, characterized in comprising holding means for holding an accumulation of a difference between a preset target band and an actually output band or history of said difference, and means for changing a congestion control parameter representing an increment and a decrement of a congestion window based on a value held in said holding means.

The 31st invention for solving the above-mentioned problem, in the above-mentioned 30th invention, is characterized in setting a smaller decrement of the congestion window in a congestive state as a value held in said holding means becomes larger.

The 32nd invention for solving the above-mentioned problem, in the above-mentioned 30th invention, is characterized in including means for modifying said target band based on a value held in said holding means.

The 33rd invention for solving the above-mentioned problem, in the above-mentioned 30th invention, is characterized in including means for deriving a value of a target congestion window based on either a preset target band or a modified target band, and means for setting the decrement of said congestion window in a congestive state based on a value of said target congestion window.

The 34th invention for solving the above-mentioned problem, in the above-mentioned 30th invention, is characterized in including a first counter for incrementing a count value according to an amount of received data and decrementing the count value according to said target band, and a second counter for incrementing a count value along with the count value decremented at said first counter and decrementing the count value according to an amount of data actually output from the node itself, and that the count value of said second counter is defined as a value held in said holding means.

The 35th invention for solving the above-mentioned problem, in the above-mentioned 30th invention, is characterized in, when the congestion window after decremented is equal to or smaller than a half of the congestion window before decremented, setting said congestion window after decremented to a half of said congestion window before decremented.

The 36th invention for solving the above-mentioned problem, in the above-mentioned 30th invention, is characterized in including means for calculating an upper limit of the congestion window based on a degree of congestion of said network, and in decrementing the congestion window in a congestive state, at least decrementing said congestion window equal to or smaller than said upper limit.

The 37th invention for solving the above-mentioned problem, in the above-mentioned 36th invention, is characterized in calculating the upper limit of said congestion window by performing subtraction of a certain value from, or multiplication of a certain value with, a value of the congestion window immediately before detection of packet discard.

The 38th invention for solving the above-mentioned problem, in the above-mentioned 36th invention, is characterized in setting the upper limit of said congestion window to a smaller value in proportion to a frequency of retransmission timeout.

The 39th invention for solving the above-mentioned problem, in the above-mentioned 30th invention, is characterized in including means for setting a larger increment of the congestion window in a non-congestive state as a value held in said holding means becomes larger.

The 40th invention for solving the above-mentioned problem, in the above-mentioned 30th invention, is characterized in including means for deriving a value of a target congestion window based on either a preset target band or a modified target band, and means for setting an increment of the congestion window in a non-congestive state based on a value of said target congestion window and a value of a current congestion window.

The 40th invention for solving the above-mentioned problem, in the above-mentioned 30th invention, is characterized in including means for changing the increment of said congestion window in a non-congestive state to a larger value when a value of a current congestion window is smaller than a value of said target congestion window, and means for changing said increment to a smaller value as a round trip transfer delay time becomes larger.

The 42nd invention for solving the above-mentioned problem, in the above-mentioned 30th invention is a relay node in a communication system for conducting data transmission/reception among a plurality of communication terminals via a network, for relaying communication between said communication terminals, characterized in comprising holding means for holding an accumulation of a difference between an input band from a communication terminal on a transmitting side and a target band or history of said difference, and means for dividing delivery acknowledgement response packets to be sent back to said communication terminal on a transmitting side based on a value held in said holding means.

The 43rd invention for solving the above-mentioned problem, in the above-mentioned 42nd invention, is characterized in including means for dividing a plurality of delivery acknowledgement response packets having a gradually increasing sequence number for acknowledging reception of one data packet and sending the delivery acknowledgement response packets back to said communication terminal on a transmitting side, and that the number of said divided delivery acknowledgement response packets is set to a larger value as a value held in said holding means becomes larger.

The 44th invention for solving the above-mentioned problem is a communication method for use in a communication system for conducting data transmission/reception among a plurality of communication terminals via a network, and including a relay node for relaying communication between said communication terminals, characterized in that either said communication terminal or said relay node executes processing for holding an accumulation of a difference between a preset target band and an actually output band or history of said difference in holding means, and processing for changing a congestion control parameter representing an increment and a decrement of a congestion window based on a value held in said holding means.

The 45th invention for solving the above-mentioned problem, in the above-mentioned 44th invention, is characterized in that either said communication terminal or said relay node sets a smaller decrement of the congestion window in a congestive state as a value held in said holding means becomes larger.

The 46th invention for solving the above-mentioned problem, in the above-mentioned 44th invention, is characterized in that either said communication terminal or said relay node executes processing for modifying said target band based on a value held in said holding means.

The 47th invention for solving the above-mentioned problem, in the above-mentioned 44th invention, is characterized in that either said communication terminal or said relay node executes processing for deriving a value of a target congestion window based on either a preset target band or a modified target band, and processing for setting the decrement of said congestion window in a congestive state based on a value of said target congestion window.

The 48th invention for solving the above-mentioned problem, in the above-mentioned 44th invention, is characterized in that the communication terminal on a transmitting side executes processing for incrementing a count value according to an amount of generated transmitted data and decrementing the count value according to said target band at a first counter, and processing for incrementing a count value along with the count value decremented at said first counter and decrementing the count value according to an amount of data actually output from the terminal itself at a second counter, and the count value of said second counter is defined as a value held in said holding means.

The 46th invention for solving the above-mentioned problem, in the above-mentioned 44th invention, is characterized in that said relay node executes processing for incrementing a count value according to an amount of received data and decrementing the count value according to said target band at a first counter, and processing for incrementing a count value along with the count value decremented at said first counter and decrementing the count value according to an amount of data actually output from the node itself at a second counter, and the count value of said second counter is defined as a value held in said holding means.

The 50th invention for solving the above-mentioned problem, in the above-mentioned 45th invention, is characterized in that, when the congestion window after decremented is equal to or smaller than a half of the congestion window before decremented, either said communication terminal or said relay node sets said congestion window after decremented to a half of said congestion window before decremented.

The 51st invention for solving the above-mentioned problem, in the above-mentioned 44th invention, is characterized in that either said communication terminal or said relay node executes processing for calculating an upper limit of the congestion window based on a degree of congestion of said network, and in decrementing the congestion window in a congestive state, at least decrements said congestion window equal to or smaller than said upper limit.

The 52nd invention for solving the above-mentioned problem, in the above-mentioned 51st invention, is characterized in that either said communication terminal or said relay node calculates the upper limit of said congestion window by performing subtraction of a certain value from, or multiplication of a certain value with, a value of the congestion window immediately before detection of packet discard.

The 53rd invention for solving the above-mentioned problem, in the above-mentioned 51st invention, is characterized in that either said communication terminal or said relay node sets the upper limit of said congestion window to a smaller value in proportion to a frequency of retransmission timeout.

The 54th invention for solving the above-mentioned problem, in the above-mentioned 44th invention, is characterized in that either said communication terminal or said relay node executes processing for setting a larger increment of the congestion window in a non-congestive state as a value held in said holding means becomes larger.

The 55th invention for solving the above-mentioned problem, in the above-mentioned 44th invention, is characterized in that either said communication terminal or said relay node executes processing for deriving a value of a target congestion window based on either a preset target band or a modified target band, and processing for setting an increment of the congestion window in a non-congestive state based on a value of said target congestion window and a value of a current congestion window.

The 56th invention for solving the above-mentioned problem, in the above-mentioned 55th invention, is characterized in that either said communication terminal or said relay node executes processing for changing the increment of said congestion window in a non-congestive state to a larger value when a value of the current congestion window is smaller than a value of said target congestion window, and processing for changing said increment to a smaller value as a round trip transfer delay time becomes larger.

The 57th invention for solving the above-mentioned problem is a communication method for use in a communication system for conducting data transmission/reception among a plurality of communication terminals via a network, and including a relay node for relaying communication between said communication terminals, characterized in that either a communication terminal on a receiving side or said relay node executes processing for holding an accumulation of a difference between an input band from a communication terminal on a transmitting side and a target band or history of said difference in holding means, and processing for dividing delivery acknowledgement response packets to be sent back to said communication terminal on a transmitting side based on a value held in said holding means.

The 58th invention for solving the above-mentioned problem, in the above-mentioned 57th invention, is characterized in that either said communication terminal on a receiving side or said relay node includes processing for dividing a plurality of delivery acknowledgement response packets having a gradually increasing sequence number for acknowledging reception of one data packet and sending the delivery acknowledgement response packets back to said communication terminal on a transmitting side, and the number of said divided delivery acknowledgement response packets is set to a larger value as a value held in said holding means becomes larger.

The 9th invention for solving the above-mentioned problem is a program for a communication method for use in a communication system for conducting data transmission/reception among a plurality of communication terminals via a network, and including a relay node for relaying communication between said communication terminals, said program causing a computer in either said communication terminal or said relay node to execute processing for holding an accumulation of a difference between a preset target band and an actually output band or history of said difference in holding means, and processing for changing a congestion control parameter representing an increment and a decrement of a congestion window based on a value held in said holding means.

That is, for achieving the aforementioned objects, the communication system of the present invention is a communication system for conducting data transmission/reception among a plurality of terminals via a network, characterized in that a transmitting terminal or a relay node for relaying communication between the terminals holds an accumulation of a difference between a target band and an actually output band or history of the difference, and changes a congestion control parameter based on the value of accumulation or history of the difference.

In such a context, the communication system of the present invention regulates a throughput such that a band specified by a user can be achieved independent of the condition of the network, wherein the band specified by the user is defined as a target band. Moreover, the congestion control parameter in TCP (transmission control protocol) represents the increment/decrement for a congestion window in processing of incrementing the congestion window in a non-congestive state and decrementing it in a congestive state. Furthermore, the congestion window represents an upper limit of the number of packets that can be output beyond a set value according to an acknowledgement from a receiving side.

Another communication system of the present invention is characterized in having means for modifying a target band in the short term based on the aforementioned value of accumulation, means for deriving a value of a target congestion window based on the modified target band, and means for setting a decrement of the congestion window in a congestive state based on the value of the target congestion window, all the means being provided in a transmitting terminal or in a relay node for relaying communication between the terminals.

Still another communication system of the present invention is characterized in having means for calculating an upper limit of a congestion window based on the degree of congestion of a network, the means being provided in a transmitting terminal or a relay node for relaying communication between the terminals, and when the congestion window is to be reduced in a congestive state, the congestion window is at least reduced below the upper limit.

Yet still another communication system of the present invention is characterized in having means for modifying a target band in the short term based on the aforementioned value of accumulation, means for deriving a value of a target congestion window based on the modified target band, and means for setting an increment of the congestion window in a non-congestive state based on the target congestion window value and current congestion window value, all the means being provided in a transmitting terminal or a relay node for relaying communication between the terminals.

Thus, according to the communication system of the present invention, band control can be introduced by merely changing a TCP transmitting terminal, so that a band control service can be implemented with low cost without replacing the nodes in a network.

Moreover, according to the communication system of the present invention, the amount of window size modification upon detection of congestion is optimized by flexibly changing the window size according to the degree of congestion, so that the throughput of a TCP session can be controlled according to a target band without putting the network into a serious congestive state.

### EFFECTS OF THE INVENTION

By applying the present invention having the configuration and operation described below, there is provided an effect that the throughput of a TCP session can be controlled according to a target band without putting the network into a serious congestive state.

### BRIEF DESCRIPTION OF THE DRAWINGS

FIG. 1 A block diagram showing a configuration of a transmitting terminal in accordance with one embodiment of the present invention.

FIG. 2 A flow chart showing an operation of the transmitting terminal in accordance with the one embodiment of the present invention.

FIG. 3 A diagram for explaining an operation of an accumulative band difference calculating section in accordance with the one embodiment of the present invention.

FIG. 4 A block diagram showing a configuration of a transmitting terminal in accordance with other embodiment of the present invention.

FIG. 5 A flow chart showing an operation of the transmitting terminal in accordance with the other embodiment of the present invention.

FIG. 6 A block diagram showing a configuration of a relay node in accordance with yet another embodiment of the present invention.

FIG. 7 A flow chart showing an operation of the relay node in accordance with the yet another embodiment of the present invention.

### EXPLANATION OF SYMBOLS

1, 2: Terminal
3: Relay node
11: Data generating section
12, 32: Data transmission control section
13, 33: Packet transmitting section
14, 34: ACK receiving section
15, 35: Congestion deciding section
16, 23, 36: Congestion window determining section
17, 37: Target band setting section
18, 38: Accumulative band difference calculating section
19, 39: Congestion window limit value calculating section
20, 40: Target congestion window calculating section
21, 41: Congestion window decrement calculating section
22: Congestion window increment calculating section
31: Data reception control section
42: Packet receiving section
43: ACK transmitting section

### BEST MODES FOR CARRYING OUT THE INVENTION

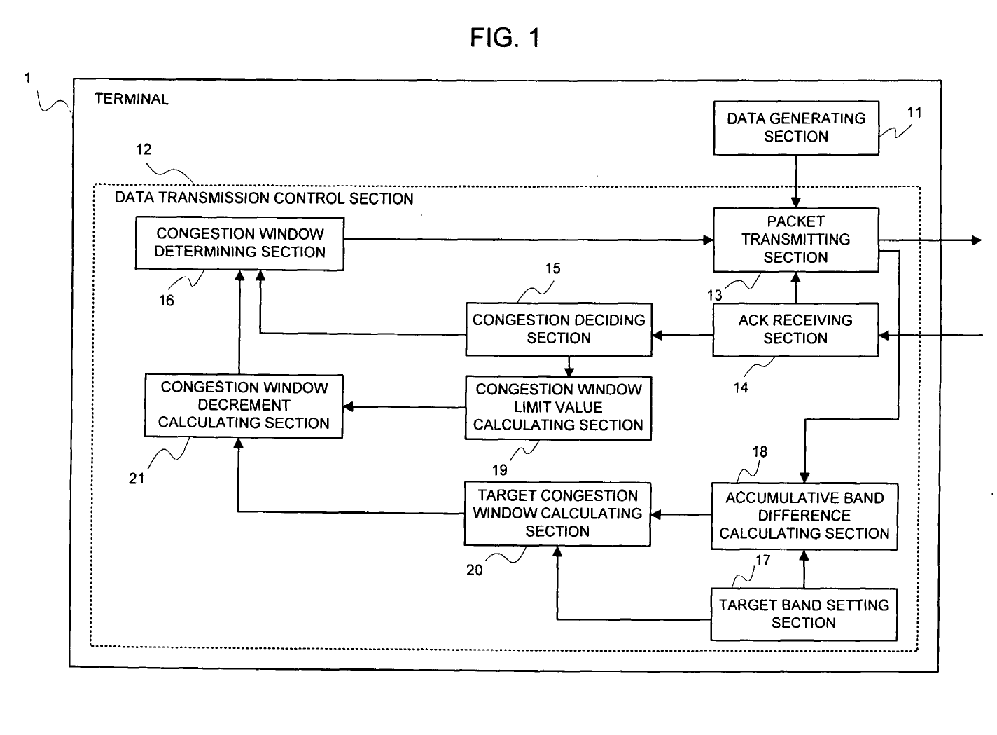

Next, embodiments of the present invention will be described with reference to the accompanying drawings. FIG. 1 is a block diagram showing a configuration of a transmitting terminal in accordance with one embodiment of the present invention. In FIG. 1, a terminal 1 is comprised of a data generating section 11 in which data to be transmitted is generated, and a data transmission control section 12 for transmitting the generated data.

The data transmission control section 12 is comprised of a packet transmitting section 13 for controlling packet output according to a given congestion window, an ACK (acknowledgement) receiving section 14 for receiving a delivery acknowledgement packet from a receiving terminal (not shown), a congestion deciding section 15 for determining the degree of congestion of a network by detecting packet discard, and a congestion window determining section 16 for determining a size of a congestion window.

It should be noted that the present embodiment regulates a throughput such that a band specified by a user can be achieved independent of the condition of the network, wherein the band specified by the user is defined as a target band. Moreover, a congestion control parameter in TCP (transmission control protocol) represents the increment/decrement of a congestion window in processing of incrementing the congestion window in a non-congestive state and decrementing it in a congestive state. Furthermore, the congestion window represents an upper limit of the number of packets that can be output beyond a set value according to an acknowledgement from a receiving side.

In addition, the configuration in accordance with the present embodiment comprises in the data transmission control section 12 a target band setting section 17 for storing therein a target transmission band, an accumulative band difference calculating section 18 for calculating an accumulation or history of the difference between the target band and an actually output band, a congestion window limit value calculating section 19 for determining an upper limit of the congestion window from the degree of congestion of a network, a target congestion window calculating section 20 for determining a size of the congestion window required to achieve the target band, and a congestion window decrement calculating section 21 for determining a decrement of the congestion window from the target congestion window upon detection of congestion.

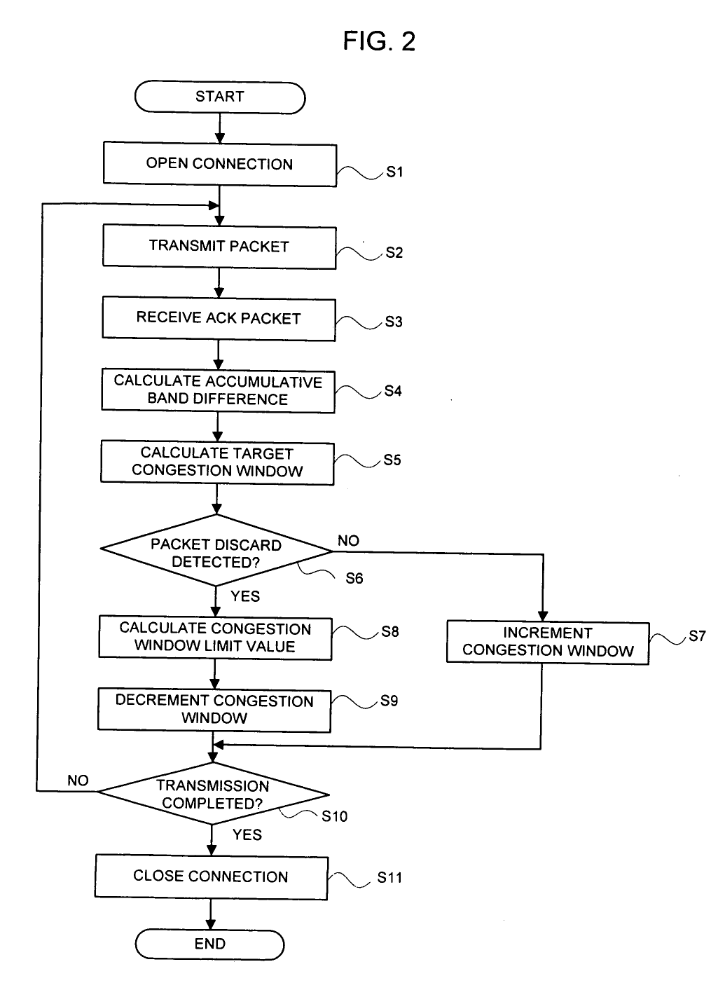

FIG. 2 is a flow chart showing an operation of the transmitting terminal in accordance with the one embodiment of the present invention. The operation of the terminal 1 in accordance with the one embodiment of the present invention will now be described with reference to FIGS. 1 and 2. It should be noted that the processing shown in FIG. 2 may be implemented by a CPU (central processing unit; not shown) in the terminal 1 executing a computer-executable program.

Upon opening of a connection (Step S1 in FIG. 2), the terminal 1 outputs a packet generated at the data generating section 11 from the packet transmitting section 13 (Step S2 in FIG. 2). After an ACK packet has been sent back from a receiving side as a delivery acknowledgement for the transmitted packet, the terminal 1 receives the packet at the ACK receiving section 14 (Step S3 in FIG. 2).

On receipt of the ACK packet, the packet transmitting section 13 in the terminal 1 outputs a next packet and at the same time the congestion deciding section 15 checks whether packet discard has occurred (Step S6 in FIG. 2). When the congestion deciding section 15 does not detect any packet discard, the terminal 1 increments the congestion window by one unit of MSS (maximum segment size; the net maximum data length that can be transmitted/received) at the congestion window determining section 16 (Step S7 in FIG. 2). On the other hand, when packet discard is detected, the terminal 1 performs processing described below according to the present embodiment unlike TCP-Reno (see Non-patent Document 2, for example) in which the congestion window is decremented by half.

First, the terminal 1 calculates an accumulation or history of the difference between the target band and actually output band at the accumulative band difference calculating section 18 when the ACK packet is received (Step S4 in FIG. 2).

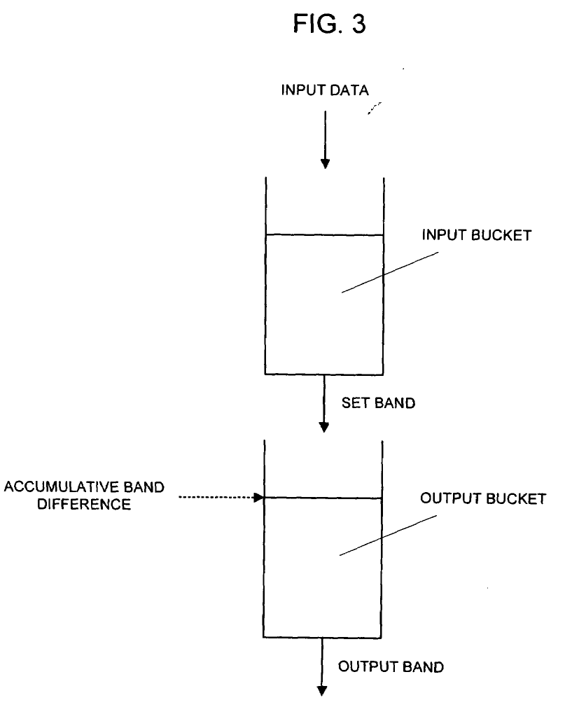

The calculation of the difference will now be described with reference to FIG. 3. The accumulative band difference calculating section 18 holds an accumulation of a difference between an amount of generated data and the target band or history of the difference in an input bucket, and the amount of data output from the input bucket is a target amount of data which should be output from the terminal 1.

The accumulative band difference calculating section 18 also holds a difference between the amount of data output from the input bucket and the accumulation of the amount of data actually output from the terminal 1 in an output bucket. Therefore, the amount of accumulation in the output bucket represents an accumulation of the difference between the target band and actually output band or history of the difference, where an amount having a positive value indicates that the output band has not reached the target band, and that having a negative value indicates that the output band is greater than the target band.

The target congestion window calculating section 20 determines a short-term target band in order to bring the accumulative band difference closer to zero as in the following equation:

Short-term Target Band=Target Band+Accumulated Band Difference/Time Constant. (1)

Next, the target congestion window calculating section 20 determines a target congestion window as in the following equation:

Target Congestion Window=Short−term Target Band×Round-trip Propagation Delay Time. (2)

The congestion window limit value calculating section 19 determines an upper limit of the congestion window according to the following equation:

Congestion Window Limit Value=Current Congestion Window Size−Maximum Segment Size×2. (3)

However, in a case that serious congestion is assumed to occur in the network, that is, for example, when transmission timeout is frequently encountered, the congestion window limit value is set smaller than that as in EQ. (3).

Upon detection of packet discard, the terminal 1 sets a new congestion window to a smaller one of the target congestion window and congestion window limit value, rather than decrementing the congestion window by half. However, when the new congestion window is smaller than a half of the original value, the congestion window is decremented by half similarly to TCP-Reno. A purpose thereof is to obtain a band approximating that according to TCP-Reno when the network has a surplus of band and the band that is probably obtained according to TCP-Reno is larger than the target band. That is, in the present embodiment, it is possible to make control so as to prevent the throughput from dropping below the target band, instead of the throughput fixed to a target band.

Thus, according to the present embodiment, control can be made so as to prevent the throughput from dropping below the target band by optimizing the decrement of the congestion window according to the target band upon detection of packet discard.

Moreover, according to the present embodiment, an upper limit for the congestion window is defined to thereby prevent generation of serious congestion in a network, and a target congestion window is flexibly defined using an accumulation or history of the difference between the target band and actually output band to thereby cause the output band to follow the target band while tolerating variation of the output band.

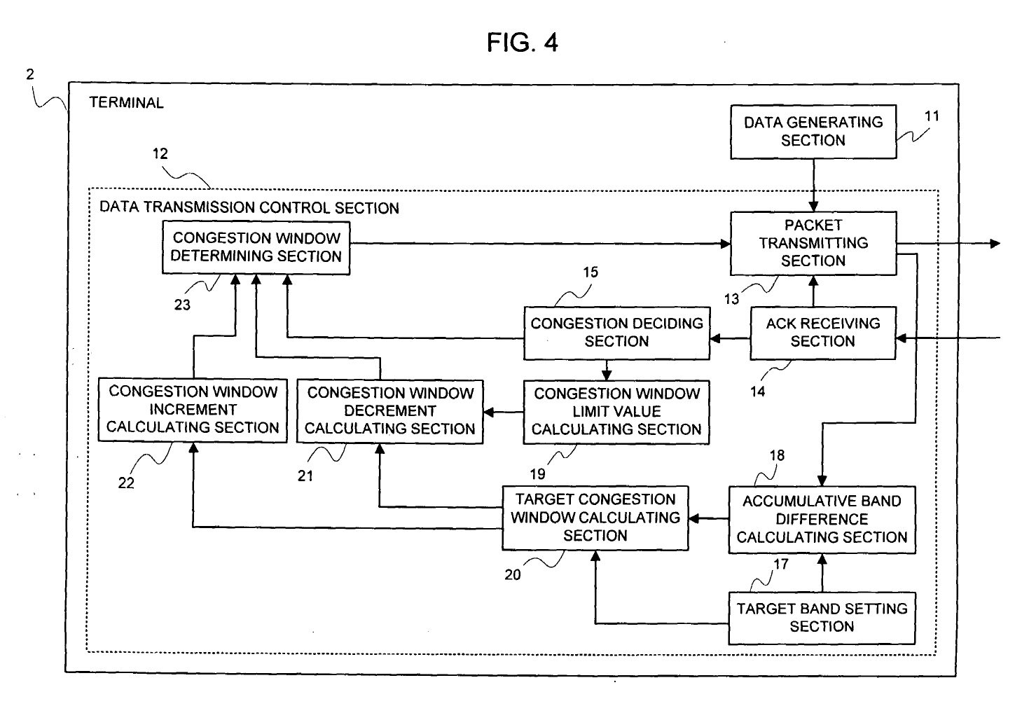

FIG. 4 is a block diagram showing a configuration of a transmitting terminal in accordance with other embodiment of the present invention. In FIG. 4, a terminal 2 according to the other embodiment of the present invention has a similar configuration to that of the terminal 1 according to the one embodiment of the present invention shown in FIG. 1, except that the configuration of the data transmission control section 12 is additionally provided with a congestion window increment calculating section 22 for changing the congestion window increment in a non-congestive state, and a congestion window deciding section 23 is provided, in place of the congestion window deciding section 16, for determining a congestion window taking account of the result of a calculation by the congestion window increment calculating section 22. In the drawing, like components are shown with like reference symbols. Moreover, the operation of like components is similar to that in the one embodiment of the present invention.

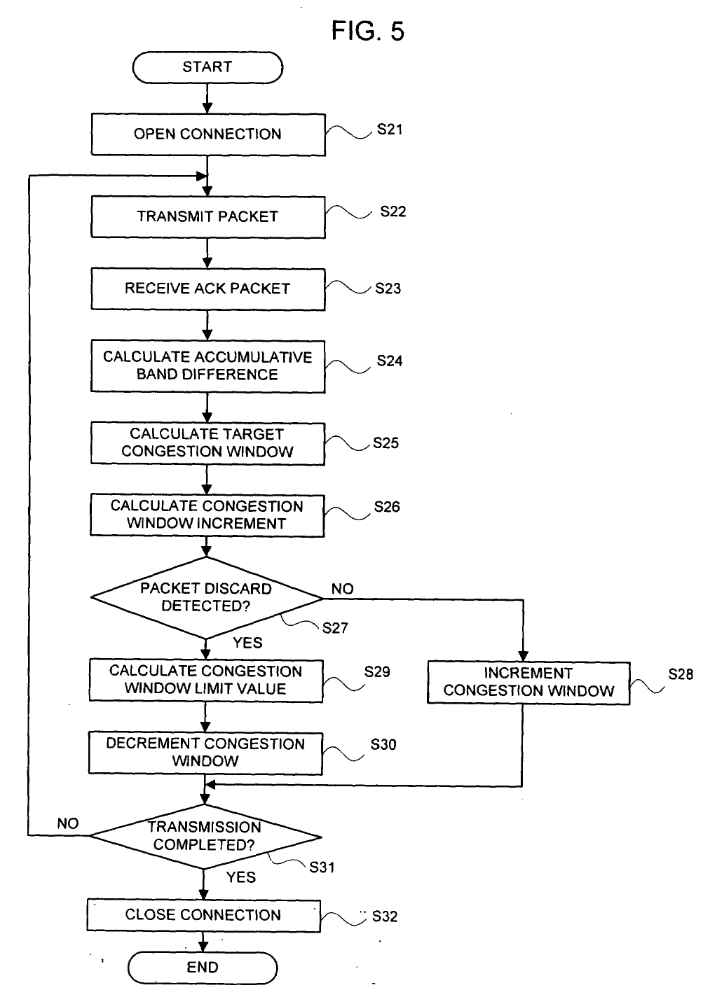

FIG. 5 is a flow chart showing an operation of the transmitting terminal in accordance with the other embodiment of the present invention. The operation of the terminal 2 in accordance with the other embodiment of the present invention will now be described with reference to FIGS. 4 and 5. It should be noted that the processing shown in FIG. 5 may be implemented by a CPU (not shown) in the terminal 2 executing a computer-executable program. Moreover, since processing at Steps S21-S25, and S27-S32 in FIG. 5 are similar to those in Steps S1-S11 in FIG. 2, explanation thereof will be omitted.

The operation of the terminal 2 in the present embodiment is generally similar to that in the terminal 1 in the one embodiment of the present invention, except processing at Step S26 in FIG. 5, i.e., processing of calculating an increment of the congestion window after the ACK packet is received. When the current congestion window is greater than the target congestion window, the congestion window increment calculating section 22 sets the congestion window incremented by one unit of MSS (maximum segment size) as in the one embodiment of the present invention described above. Otherwise, it sets the congestion window incremented by N×MSS, where N represents a whole number equal to or greater than one, and may be preset to a fixed value or dynamically set to a value in proportion to a bottle-neck link band.

Moreover, N may be dynamically changed based on a measured value of RTT (round trip time), for example, according to the following equation:

N=1+AeB(RTT−Min. RTT)/(Max. RTT−Min. RTT), (4)

where A and B are preset values equal to or greater than zero.

Thus, according to the present embodiment, the congestion window is steeply incremented when it has not reached the target value, and therefore, the throughput can be made to more quickly follow the target band.

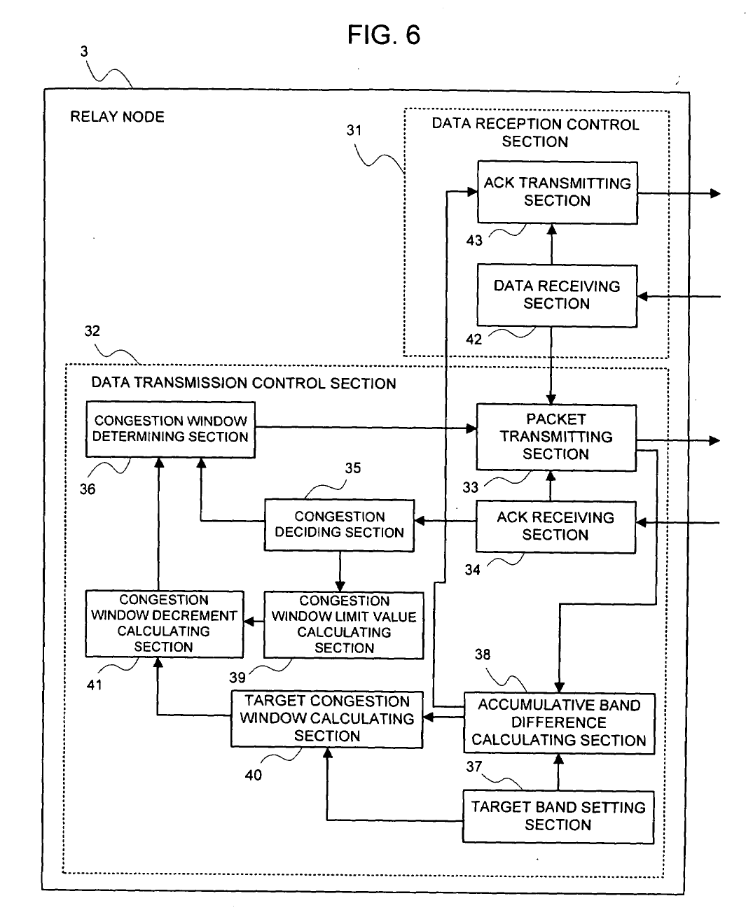

FIG. 6 is a block diagram showing a configuration of a relay node in accordance with yet another embodiment of the present invention. In FIG. 6, a relay node 3 is comprised of a data reception control section 31 for receiving data from a transmitting terminal (not shown), and a data transmission control section 32 for transmitting the received data to a receiving terminal (not shown).

The data reception control section 31 is comprised of a packet receiving section 42 for receiving a data packet transmitted by a transmitting terminal, and an ACK transmitting section 43 for sending an ACK packet generated in response to the received packet back to the transmitting terminal. The configuration of the data transmission control section 32 is similar to that in the data transmission control section 12 in the one embodiment of the present invention shown in FIG. 1, and is comprised of a packet transmitting section 33, an ACK receiving section 34, a congestion deciding section 35, a congestion window determining section 36, a target band setting section 37, an accumulative band difference calculating section 38, a congestion window limit value calculating section 39, a target congestion window calculating section 40, and a congestion window decrement calculating section 41.

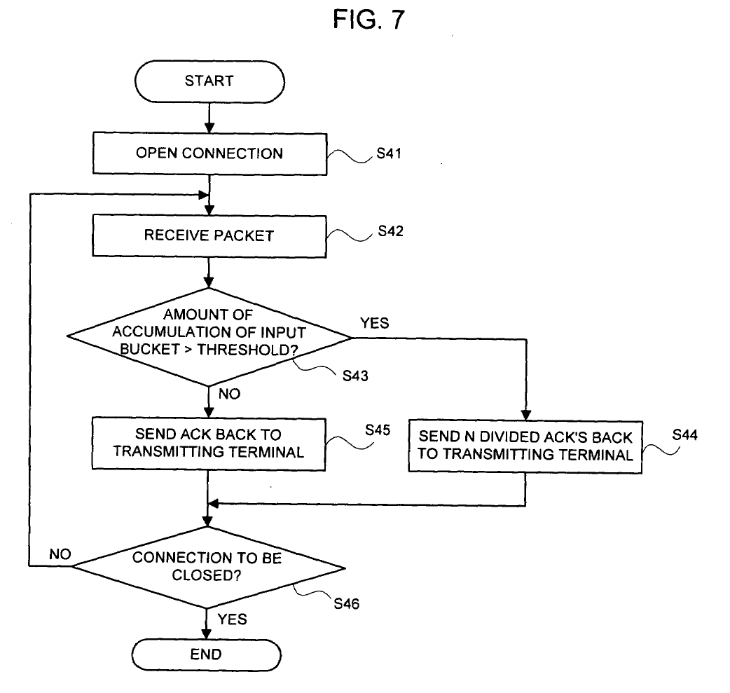

FIG. 7 is a flow chart for explaining an operation of the relay node 3 in accordance with the yet another embodiment of the present invention. The operation of the relay node 3 in accordance with the yet another embodiment of the present invention will now be described with reference to FIGS. 6 and 7. It should be noted that the processing shown in FIG. 7 may be implemented by a CPU (not shown) in the relay node 3 executing a computer-executable program.

The present embodiment illustrates an example in which the present invention is applied to a session relay node instead of a transmitting terminal. The session relay node opens a session with a transmitting terminal and that with a receiving terminal (Step S41 in FIG. 7), and relays data between the sessions to achieve communication between the transmitting and receiving terminals.

In the present embodiment, a packet output by the transmitting terminal is received at the packet receiving section 42 in the data reception control section 31 (Step S42 in FIG. 7), and the packet is passed to the data transmission control section 32 to be output by the packet transmitting section 33 to the receiving terminal. Since the operation of the data transmission control section 32 is similar to that in the one embodiment of the present invention, explanation thereof will be omitted.

The operation of the data reception control section 31 is similar to packet reception processing at a common receiving terminal, in which an ACK packet corresponding to a packet received at the packet receiving section 42 is generated at the ACK transmitting section 43 and sent back to the transmitting terminal. However, the operation of the ACK transmitting section 43 is different from the common receiving terminal in a point described below.

The ACK transmitting section 43 monitors the amount of accumulation of the input bucket kept by the accumulative band difference calculating section 38 (Step S43 in FIG. 7), and when the amount is smaller than a predetermined threshold, the ACK transmitting section 43 generates one ACK packet in response to a received packet and sends it back to the transmitting terminal (Step S45 in FIG. 7), as with the operation in the common receiving terminal.

When the amount of accumulation of the input bucket is equal to or greater than the threshold, the ACK transmitting section 43 generates a plurality of ACK packets depending upon the amount of accumulation, and sends them back to the transmitting terminal (Step S44 in FIG. 7). For example, when packets up to Segment 1000 have been previously received and packets up to Segment 2500 are currently received, an ACK packet in response to Segment 2500 should be output in a common case; however, here, three ACK packet in response to Segments 1500, 2000, 2500 are output in a case that three ACK packets are to be generated.

The number of output ACK packets is determined as in the following equation:

Number of Output Packets=1+(Amount of Accumulation in Input Bucket/MSS)/(Number of Packets Arriving in One Second×Time Constant). (5)

Thus, according to the present embodiment, band control can be implemented by adding one or more session relay nodes in a network without changing existing transmitting or receiving terminals. Moreover, according to the present embodiment, the band between the relay node and receiving terminal can be controlled, and in addition, that between the relay node and transmitting terminal can be controlled as well by dividing ACK's to the transmitting terminal.

1. A communication system for conducting data transmission/reception among a plurality of communication terminals via a network, and including a relay node for relaying communication between said communication terminals,
characterized in that either said communication terminal or said relay node comprises holding means for holding an accumulation of a difference between a preset target band and an actually output band or history of said difference, and means for changing a congestion control parameter representing an increment and a decrement of a congestion window based on a value held in said holding means.

2. A communication system recited in claim 1, characterized in that either said communication terminal or said relay node sets a smaller decrement of a congestion window in a congestive state as a value held in said holding means becomes larger.

3. A communication system recited in claim 1, characterized in that either said communication terminal or said relay node includes means for modifying said target band based on a value held in said holding means.

4. A communication system as recited in claim 1, characterized in that either said communication terminal or said relay node comprises means for deriving a value of a target congestion window based on either a preset target band or a modified target band, and means for setting a decrement of a congestion window in a congestive state based on a value of said target congestion window.

5. A communication system recited in claim 1, characterized in that a communication terminal on a transmitting side includes a first counter for incrementing a count value according to an amount of generated transmitted data and decrementing the count value according to said target band, and a second counter for incrementing a count value along with the count value decremented at said first counter and decrementing the count value according to an amount of data actually output from the terminal itself, and the count value of said second counter is defined as a value held in said holding means.

6. A communication system recited in claim 1, characterized in that said relay node includes a first counter for incrementing a count value according to an amount of received data and decrementing the count value according to said target band, and a second counter for incrementing a count value along with the count value decremented at said first counter and decrementing the count value according to an amount of data actually output from the node itself, and the count value of said second counter is defined as a value held in said holding means.

7. A communication system recited in claim 2, characterized in that, when the congestion window after decremented is equal to or smaller than a half of the congestion window before decremented, either said communication terminal or said relay node sets said congestion window after decremented to a half of said congestion window before decremented.

8. A communication system recited in claim 1, characterized in that either said communication terminal or said relay node includes means for calculating an upper limit of the congestion window based on a degree of congestion of said network, and in decrementing the congestion window in a congestive state, at least decrements said congestion window equal to or smaller than said upper limit.

9. A communication system recited in claim 8, characterized in that either said communication terminal or said relay node calculates the upper limit of said congestion window by performing subtraction of a certain value from, or multiplication of a certain value with, a value of the congestion window immediately before detection of packet discard.

10. A communication system recited in claim 8, characterized in that either said communication terminal or said relay node sets the upper limit of said congestion window to a smaller value in proportion to a frequency of retransmission timeout.

11. A communication system recited in claim 1, characterized in that either said communication terminal or said relay node includes means for setting a larger increment of the congestion window in a non-congestive state as a value held in said holding means becomes larger.

12. A communication system recited in claim 1, characterized in that either said communication terminal or said relay node includes means for deriving a value of the target congestion window based on either a preset target band or a modified target band, and means for setting an increment of the congestion window in a non-congestive state based on a value of said target congestion window and a value of a current congestion window.

13. A communication system recited in claim 1, characterized in that either said communication terminal or said relay node includes means for changing an increment of said congestion window in a non-congestive state to a larger value when a value of the current congestion window is smaller than a value of said target congestion window, and means for changing said increment to a smaller value as a round trip transfer delay time becomes larger.

14. A communication system for conducting data transmission/reception among a plurality of communication terminals via a network, and including a relay node for relaying communication between said communication terminals,
characterized in that either a communication terminal on a receiving side or said relay node comprises holding means for holding an accumulation of a difference between an input band from a communication terminal on a transmitting side and a target band or history of said difference, and means for dividing delivery acknowledgement response packets to be sent back to said communication terminal on a transmitting side based on a value held in said holding means.

15. A communication system recited in claim 14, characterized in that either said communication terminal on a receiving side or said relay node includes means for dividing a plurality of delivery acknowledgement response packets having a gradually increasing sequence number for acknowledging reception of one data packet and sending the delivery acknowledgement response packets back to said communication terminal on a transmitting side, and sets the number of said divided delivery acknowledgement response packets to a larger value as a value held in said holding means becomes larger.

16. A communication terminal for conducting data transmission/reception with other communication terminal via a network,
characterized in comprising holding means for holding an accumulation of a difference between a preset target band and an actually output band or history of said difference, and means for changing a congestion control parameter representing an increment and a decrement of a congestion window based on a value held in said holding means.

17. A communication terminal recited in claim 16, characterized in setting a smaller decrement of the congestion window in a congestive state as a value held in said holding means becomes larger.

18. A communication terminal recited in claim 16, characterized in including means for modifying said target band based on a value held in said holding means.

19. A communication terminal recited in claim 18, characterized in including means for deriving a value of a target congestion window based on either the preset target band or the modified target band, and means for setting a decrement of said congestion window in a congestive state based on a value of said target congestion window.

20. A communication terminal recited in claim 16, characterized in including a first counter for incrementing a count value according to an amount of generated transmitted data and decrementing the count value according to said target band, and a second counter for incrementing a count value along with the count value decremented at said first counter and decrementing the count value according to an amount of data actually output by the terminal itself, and that the count value of said second counter is defined as a value held in said holding means.

21. A communication terminal recited in claim 17, characterized in that, when the congestion window after decremented is equal to or smaller than a half of the congestion window before decremented, said congestion window after decremented is set to a half of said congestion window before decremented.

22. A communication terminal recited in claim 16, characterized in including means for calculating an upper limit of the congestion window based on a degree of congestion of said network, and in decrementing the congestion window in a congestive state, at least decrementing said congestion window equal to or smaller than said upper limit.

23. A communication terminal recited in claim 22, characterized in calculating the upper limit of said congestion window by performing subtraction of a certain value from, or multiplication of a certain value with, a value of the congestion window immediately before detection of packet discard.

24. A communication terminal recited in claim 22, characterized in setting the upper limit of said congestion window to a smaller value in proportion to a frequency of retransmission timeout.

25. A communication terminal recited in claim 16, characterized in including means for setting a larger increment of the congestion window in a non-congestive state as a value held in said holding means becomes larger.

26. A communication terminal recited in claim 16, characterized in including means for deriving a value of the target congestion window based on either a preset target band or a modified target band, and means for setting an increment of the congestion window in a non-congestive state based on a value of said target congestion window and a value of a current congestion window.

27. A communication terminal recited in claim 26, characterized in including means for changing an increment of said congestion window in a non-congestive state to a larger value when a value of the current congestion window is smaller than a value of said target congestion window, and means for changing said increment to a smaller value as a round trip transfer delay time becomes larger.

28. A communication terminal for conducting data transmission/reception with other communication terminal via a network,
characterized in comprising holding means for holding an accumulation of a difference between an input band from a communication terminal on a transmitting side and a target band or history of said difference, and means for dividing delivery acknowledgement response packets to be sent back to said communication terminal on a transmitting side based on a value held in said holding means.

29. A communication terminal recited in claim 28, characterized in including means for dividing a plurality of delivery acknowledgement response packets having a gradually increasing sequence number for acknowledging reception of one data packet and sending the delivery acknowledgement response packets back to said communication terminal on a transmitting side, and that the number of said divided delivery acknowledgement response packets is set to a larger value as a value held in said holding means becomes larger.

30. A relay node in a communication system for conducting data transmission/reception among a plurality of communication terminals via a network, for relaying communication between said communication terminals,
characterized in comprising holding means for holding an accumulation of a difference between a preset target band and an actually output band or history of said difference, and means for changing a congestion control parameter representing an increment and a decrement of a congestion window based on a value held in said holding means.

31. A relay node recited in claim 30, characterized in setting a smaller decrement of the congestion window in a congestive state as a value held in said holding means becomes larger.

32. A relay node recited in claim 30, characterized in including means for modifying said target band based on a value held in said holding means.

33. A relay node recited in claim 30, characterized in including means for deriving a value of a target congestion window based on either a preset target band or a modified target band, and means for setting the decrement of said congestion window in a congestive state based on a value of said target congestion window.

34. A relay node recited in claim 30, characterized in including a first counter for incrementing a count value according to an amount of received data and decrementing the count value according to said target band, and a second counter for incrementing a count value along with the count value decremented at said first counter and decrementing the count value according to an amount of data actually output from the node itself, and that the count value of said second counter is defined as a value held in said holding means.

35. A relay node recited in claim 30, characterized in, when the congestion window after decremented is equal to or smaller than a half of the congestion window before decremented, setting said congestion window after decremented to a half of said congestion window before decremented.

36. A relay node recited in claim 30, characterized in including means for calculating an upper limit of the congestion window based on a degree of congestion of said network, and in decrementing the congestion window in a congestive state, at least decrementing said congestion window equal to or smaller than said upper limit.

37. A relay node recited in claim 36, characterized in calculating the upper limit of said congestion window by performing subtraction of a certain value from, or multiplication of a certain value with, a value of the congestion window immediately before detection of packet discard.

38. A relay node recited in claim 36, characterized in setting the upper limit of said congestion window to a smaller value in proportion to a frequency of retransmission timeout.

39. A relay node recited in claim 30, characterized in including means for setting a larger increment of the congestion window in a non-congestive state as a value held in said holding means becomes larger.

40. A relay node recited in claim 30, characterized in including means for deriving a value of a target congestion window based on either a preset target band or a modified target band, and means for setting an increment of the congestion window in a non-congestive state based on a value of said target congestion window and a value of a current congestion window.

41. A relay node recited in claim 30, characterized in including means for changing the increment of said congestion window in a non-congestive state to a larger value when a value of a current congestion window is smaller than a value of said target congestion window, and means for changing said increment to a smaller value as a round trip transfer delay time becomes larger.

42. A relay node in a communication system for conducting data transmission/reception among a plurality of communication terminals via a network, for relaying communication between said communication terminals,
characterized in comprising holding means for holding an accumulation of a difference between an input band from a communication terminal on a transmitting side and a target band or history of said difference, and means for dividing delivery acknowledgement response packets to be sent back to said communication terminal on a transmitting side based on a value held in said holding means.

43. A relay node recited in claim 42, characterized in including means for dividing a plurality of delivery acknowledgement response packets having a gradually increasing sequence number for acknowledging reception of one data packet and sending the delivery acknowledgement response packets back to said communication terminal on a transmitting side, and that the number of said divided delivery acknowledgement response packets is set to a larger value as a value held in said holding means becomes larger.

44. A communication method for use in a communication system for conducting data transmission/reception among a plurality of communication terminals via a network, and including a relay node for relaying communication between said communication terminals,
characterized in that either said communication terminal or said relay node executes processing for holding an accumulation of a difference between a preset target band and an actually output band or history of said difference in holding means, and processing for changing a congestion control parameter representing an increment and a decrement of a congestion window based on a value held in said holding means.

45. A communication method recited in claim 44, characterized in that either said communication terminal or said relay node sets a smaller decrement of the congestion window in a congestive state as a value held in said holding means becomes larger.

46. A communication method recited in claim 44, characterized in that either said communication terminal or said relay node executes processing for modifying said target band based on a value held in said holding means.

47. A communication method recited in claim 44, characterized in that either said communication terminal or said relay node executes processing for deriving a value of a target congestion window based on either a preset target band or a modified target band, and processing for setting the decrement of said congestion window in a congestive state based on a value of said target congestion window.

48. A communication method recited in claim 44, characterized in that the communication terminal on a transmitting side executes processing for incrementing a count value according to an amount of generated transmitted data and decrementing the count value according to said target band at a first counter, and processing for incrementing a count value along with the count value decremented at said first counter and decrementing the count value according to an amount of data actually output from the terminal itself at a second counter, and the count value of said second counter is defined as a value held in said holding means.

49. A communication method recited in claim 44, characterized in that said relay node executes processing for incrementing a count value according to an amount of received data and decrementing the count value according to said target band at a first counter, and processing for incrementing a count value along with the count value decremented at said first counter and decrementing the count value according to an amount of data actually output from the node itself at a second counter, and the count value of said second counter is defined as a value held in said holding means.

50. A communication method recited in claim 45, characterized in that, when the congestion window after decremented is equal to or smaller than a half of the congestion window before decremented, either said communication terminal or said relay node sets said congestion window after decremented to a half of said congestion window before decremented.

51. A communication method recited in claim 44, characterized in that either said communication terminal or said relay node executes processing for calculating an upper limit of the congestion window based on a degree of congestion of said network, and in decrementing the congestion window in a congestive state, at least decrements said congestion window equal to or smaller than said upper limit.

52. A communication method recited in claim 51, characterized in that either said communication terminal or said relay node calculates the upper limit of said congestion window by performing subtraction of a certain value from, or multiplication of a certain value with, a value of the congestion window immediately before detection of packet discard.

53. A communication method recited in claim 51, characterized in that either said communication terminal or said relay node sets the upper limit of said congestion window to a smaller value in proportion to a frequency of retransmission timeout.

54. A communication method recited in claim 44, characterized in that either said communication terminal or said relay node executes processing for setting a larger increment of the congestion window in a non-congestive state as a value held in said holding means becomes larger.

55. A communication method recited in claim 44, characterized in that either said communication terminal or said relay node executes processing for deriving a value of a target congestion window based on either a preset target band or a modified target band, and processing for setting an increment of the congestion window in a non-congestive state based on a value of said target congestion window and a value of a current congestion window.

56. A communication method recited in claim 55, characterized in that either said communication terminal or said relay node executes processing for changing the increment of said congestion window in a non-congestive state to a larger value when a value of the current congestion window is smaller than a value of said target congestion window, and processing for changing said increment to a smaller value as a round trip transfer delay time becomes larger.

57. A communication method for use in a communication system for conducting data transmission/reception among a plurality of communication terminals via a network, and including a relay node for relaying communication between said communication terminals,
characterized in that either a communication terminal on a receiving side or said relay node executes processing for holding an accumulation of a difference between an input band from a communication terminal on a transmitting side and a target band or history of said difference in holding means, and processing for dividing delivery acknowledgement response packets to be sent back to said communication terminal on a transmitting side based on a value held in said holding means.

58. A communication method recited in claim 57, characterized in that either said communication terminal on a receiving side or said relay node includes processing for dividing a plurality of delivery acknowledgement response packets having a gradually increasing sequence number for acknowledging reception of one data packet and sending the delivery acknowledgement response packets back to said communication terminal on a transmitting side, and the number of said divided delivery acknowledgement response packets is set to a larger value as a value held in said holding means becomes larger.

59. A recording medium storing a program for a communication method for use in a communication system for conducting data transmission/reception among a plurality of communication terminals via a network, and including a relay node for relaying communication between said communication terminals,
said program causing a computer in either said communication terminal or said relay node to execute processing for holding an accumulation of a difference between a preset target band and an actually output band or history of said difference in holding means, and processing for changing a congestion control parameter representing an increment and a decrement of a congestion window based on a value held in said holding means.
